(19) United States
(12) Patent Application Publication
(10) Pub. No.: US 2007/0073696 A1
(43) Pub. Date: Mar. 29, 2007

(54) Online data verification of listing data

(75) Inventors: Jeff Reynar, New York, NY (US); Jonathan Kennell, New York, NY (US); Dolapo Falola, New York, NY (US); Nikhil Chandhok, New York, NY (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Google, Inc., Mountain View, CA (US)

(21) Appl. No.: 11/236,853

(22) Filed: Sep. 28, 2005

(51) Int. Cl. G06F 17/30

(52) U.S. Cl. 707/9

(57) ABSTRACT

A system and method for online verification of data including receiving listing information associated with an entity, determining whether the listing information corresponds to an entry in a database, generating an identifier based on whether the listing information corresponds to an entry in a database, outputting the identifier to a user associated with the entity, initiating contact with the user using the listing information, receiving input from the user, and verifying the listing information using the input and the identifier.

### FIELD OF THE INVENTION

Embodiments of the present invention relate to online data verification.

### BACKGROUND OF THE INVENTION

The integrity of the information provided by online data entities is important. Online data providers that provide personal and/or commercial listings for people and/or commercial entities often times may rely on the person and/or commercial entities to provide them with the information contained in the listing.

As opposed to a phone company, who for example, may be the source of some of the information contained in a listing (e.g., the phone number), online data providers may publish listings without being the source of any of the information contained in the listing.

Because online data providers may not be the source of any of the information contained in a listing, they cannot be sure that the information they provide is accurate. To ensure the accuracy of the information provided by online data providers, online data providers may need to verify the information.

These and other drawbacks exist with current systems.

### SUMMARY OF THE INVENTION

Accordingly, various exemplary embodiments of the present inventions may be directed to a system and method for online verification of data including receiving listing information associated with an entity, determining whether the listing information corresponds to an entry in a database, generating an identifier based on whether the listing information corresponds to an entry in a database, outputting the identifier to a user associated with the entity, initiating contact with the user using the listing information, receiving input from the user, and verifying the listing information using the input and the identifier.

According to another exemplary embodiment a system may include a listing input module to receive listing information associated with an entity, a comparison module operatively connected to the listing input module to receive the listing information and determine whether the listing information corresponds to previously stored information, an identifier module that generates an identifier based on whether the listing information corresponds to previously stored information and output the identifier, a communication module to initiate contact with a device associated with the entity based on the contents of the listing information and receive input from the device, and a verification module to verify the listing information using the input and the identifier.

According to another exemplary embodiment a system may include a client device to provide listing information associated with an entity, a database including a plurality of entries, and an online data provider to receive the listing information, determine whether the listing information corresponds to one of the plurality of entries, generate an identifier, output the identifier to the client device, initiate contact with the client device, receive input from the client device, and verify the listing information using the identifier and the received input.

According to yet another exemplary embodiment of the invention a system may include a listing input module to receive listing information associated with a commercial entity, wherein the listing information includes at least one of a name, an address, a phone number, a website, an email address, or business operation information associated with the commercial entity; a comparison module operatively connected to the listing input module to receive the listing information and determine whether the listing information corresponds to previously stored information, wherein to determine whether the listing information corresponds to previously stored information, the comparison module determines whether a database contains an entry corresponding to the commercial entity and whether a match exists between a field of the entry and the listing information, based on whether the database contains an entry corresponding to the commercial entity; an identifier module that generates an identifier based on whether the listing information corresponds to previously stored information and displays the identifier on a monitor associated with the entity; a communication module to initiate contact with a device associated with the entity based on the contents of the listing information and receive input from the client device, wherein to initiate contact with the device, the communication module places a call to the device and wherein a user associated with the device types in the input on a keypad of the device; and a verification module to verify the listing information by determining whether the input from the client device matches the identifier.

According to a further exemplary embodiment of the invention, a method may include receiving listing information associated with a commercial entity, determining whether a database contains an entry corresponding to the commercial entity, determining whether a match exists between a field of the entry and the listing information, based on whether the database contains an entry corresponding to the entity, generating an identifier based on whether the listing information corresponds to an entry in a database, displaying the identifier on a monitor associated with the commercial entity, initiating contact with the user by placing a phone call to a user associated with the commercial entity using a phone number included in the listing information, receiving input from the user, and verifying the listing information determining whether the input matches the identifier.

Other embodiments may be considered.

### BRIEF DESCRIPTION OF THE DRAWINGS

FIG. 1 depicts an exemplary system for online data verification according to an embodiment of the invention.

FIG. 2 depicts an exemplary online data provider according to an embodiment of the invention.

FIG. 3 illustrates a flow chart showing an exemplary method for online data verification according to an embodiment of the invention.

FIG. 4 illustrates an exemplary interface according to an embodiment of the invention.

FIG. 5 illustrates an exemplary interface according to an embodiment of the invention.

FIG. 6 illustrates an exemplary interface according to an embodiment of the invention.

FIG. 7 illustrates an exemplary interface according to an embodiment of the invention.

### DETAILED DESCRIPTION OF EXEMPLARY EMBODIMENT(S)

Exemplary embodiments of the invention are discussed in detail below. While specific exemplary embodiments are discussed, it should be understood that this is done for illustration purposes only. A person skilled in the relevant art will recognize that other components and configuration can be used without parting from the spirit and scope of the invention.

Some embodiments of the present invention provide a system and method for online data verification. In these exemplary embodiments, an entity, such as, e.g., an individual, or a commercial entity, such as a business or a sole proprietorship, may provide listing information to an online data provider. Listing information may include without limitation, for example, the name, address, telephone or fax number, email address or Website of the entity and the like. Listing information may also include, business operation information, such as, e.g., hours of operation, methods of payment accepted (e.g., cash, checks, or debit/credit cards) and the like.

To provide the listing information to an online data provider, a user associated with the entity may use a client device. A client device may include, but is not limited to: e.g., any computer device, or communications device including, e.g., a personal computer (PC), a workstation, a mobile device, a phone, a handheld PC, a personal digital assistant (PDA), a thin client, a fat client, an network appliance, an Internet browser, a paging, an alert device, a television, an interactive television, a receiver, a tuner, a high definition (HD) television, an HD receiver, a video-on-demand (VOD) system, a server, or other device. The user may, for example, type or speak the listing information into the client device using a keyboard/keypad or microphone, respectively.

In an exemplary embodiment where the user provides listing information through the client device, the user may use a keyboard and mouse, for example, to fill in data fields on a Web page or the like and then uses a graphical user interface (e.g., clicking on a button of an interface), for example, to submit the information. In an exemplary embodiment of the invention where the user speaks the listing information into the client device, the user may speak into a microphone that is connected to the client device and voice recognition software, for example, may convert the voice data into data to be transmitted as the listing information. Other methods and techniques may also be used for data input and transmission.

The listing information may then be transmitted via a network, for example, to the online data provider. The network may include, but is not limited to: e.g., a wide area network (WAN), a local area network (LAN), a global network such as the Internet, a telephone network such as a public switch telephone network, a wireless communication network, a cellular network, an intranet, or the like, or any combination thereof. In exemplary embodiments of the invention, the network may include one, or any number of the exemplary types of networks mentioned above operating as a stand alone network or in cooperation with each other. Use of the term network herein is not intended to limit the network to a single network.

The online data provider may receive the listing information. In one exemplary embodiment of the invention, the listing information may be transmitted for the purpose of creating a new listing. In another exemplary embodiment of the invention, the listing information may be transmitted to modify an existing listing. Each entry, once verified by the online data provider, for example, may be indexed and stored by the online data provider so that users of the online data provider may access the entry to obtain the listing information via, for example, the Internet.

To begin verifying the listing information, the online data provider may determine whether the entity is listed in, e.g., a 411 database or the like, by using a lookup algorithm, for example, to match the entity with a entry in the database. If the entity is located in the database, the listing information may then be compared to the information stored in the database entry for the entity.

The online data provider may then generate an identifier, such as a randomly generated number or alphanumeric character string, using a random number/character generation algorithm, for example. An identifier may comprise an alphanumeric PIN such as 5431 or AB123, for example. This identifier may then be outputted to the client device. In an exemplary embodiment of the invention, the identifier may be displayed on a monitor of the client device via a Web page, for example. A user may then record the identifier for later use. In another exemplary embodiment of the invention, the identifier may be transmitted to the client device as an audio file to be played on the client device using a media player, for example.

Using the phone number included in the listing information, for example, the online data provider may automatically place a phone call to the entity. During the phone call, a user associated with the entity may be prompted to enter or provide the identifier that was previously transmitted to the user, for example. To provide the identifier, the user may type or speak the identifier into an audio device, such as a phone, for example. In an exemplary embodiment where the user types the identifier into the phone, the user may use a keypad on the phone, for example, to type in the identifier. In an exemplary embodiment of the invention where the user speaks the listing information into the phone, the user may speak into a microphone of the phone, for example, and voice data may be transmitted to the online data provider where it is converted into data.

The identifier transmitted to the online data provider may then be compared with the identifier that was initially transmitted to the entity. If the identifier transmitted to the online data provider matches the identifier initially transmitted to the entity, the listing information may be considered to be verified. Once verified, the online data may publish the listing information in a web-based or online index.

Overview and System Architecture

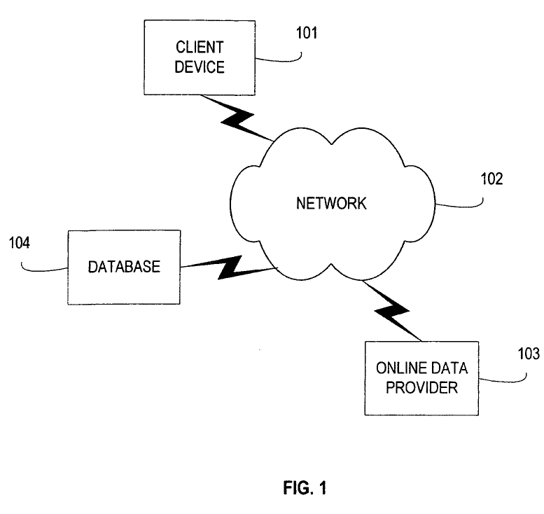

FIG. 1 depicts an exemplary system 100 for online data verification according to an embodiment of the invention. System 100 may include a client device 101, a network 102, an online data provider 103, and a database 104. In an exemplary embodiment of the invention, a client device 101 may include, but is not limited to: e.g., any computer device, or communications device including, e.g., a personal computer (PC), a workstation, a mobile device, a phone, a handheld PC, a personal digital assistant (PDA), a thin client, a fat client, an network appliance, an Internet browser, a paging, or alert device, a television, an interactive television, a receiver, a tuner, a high definition (HD) television, a HD receiver, a video-on-demand (VOD) system, a server, or other device. Further, exemplary client devices 101 may comprise a one single device, or a plurality of devices capable of carrying out the exemplary methods described herein.

For example, a client device 101 may include a personal computer connected to network 102 for transmitting to and receiving data from the network 102 and a mobile device, such as, e.g., a cellular telephone, to receive phone calls from the network.

In an exemplary embodiment of the invention, network 102 may include, but is not limited to: e.g., a wide area network (WAN), a local area network (LAN), a global network such as the Internet, a telephone network such as a public switch telephone network, a wireless communication network, a cellular network, an intranet, or the like. In exemplary embodiments of the invention, the network may include one, or any number of the exemplary types of networks mentioned above operating as a stand alone network or in cooperation with each other. As noted above, use of the term network herein is not intended to limit the network to a single network.

Online data provider 103 may be operatively connected to network 102 to receive listing information, initiate contact with a client device, and verify the listing information, for example.

In an exemplary embodiment of the invention, database 104 may be operatively connected to network 102. As noted above, database 104 may be e.g., a 411 database or the like. Such a database may provide listing information for individuals and commercial entities and may be publicly available and/or privately accessed. In another exemplary embodiment of the invention, database 104 may be operatively connected to online data provider 103 (not shown).

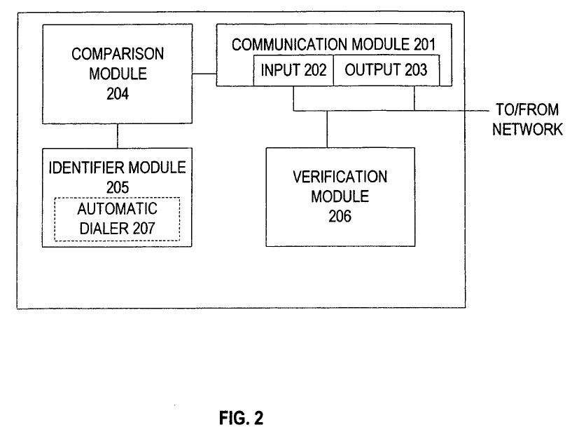

FIG. 2 depicts an exemplary online data provider 200 according to an embodiment of the invention to operate as online data provider 103. Online data provider 200 may include a communication module 201 to transmit data to an receive data from a network. Communication module 201 may transmit any type of data, including, for example, text data, voice data, graphical data, and/or telephone data using any corresponding protocols and/or methods for transmitting such data. As shown in FIG. 2, communication module 201 may include, for example, an input 202 and an output 203 for receiving and transmitting data, respectively.

Online data provider 200 may also include a comparison module 204 operatively connected to the communication module, for example, to receive the listing information and determine whether the listing information corresponds to information that was previously stored in a database or otherwise available, for example. In another exemplary embodiment of the invention, the database may be operatively coupled to online data provider 200 via a network. In another exemplary embodiment, the database may be included as part of the online data provider 200 (not shown). The comparison module 204 may include functionality to use algorithms, for example to look up entries in the database, and compare the listing information with the fields of the entries in the database. The comparison module 204 may also be capable of producing a signal or the like, for example, when a match is found between the listing information and an entry in the database. In an exemplary embodiment of the invention, this signal may be transmitted to an identifier module, for example.

Online data provider 200 may include identifier module 205. Identifier module 205 may generate an identifier, such as a unique identifier including a randomly generated number or alphanumeric string of characters. In an exemplary embodiment of the invention, this identifier may be used to verify listing information, for example. Identifier module 205 may be a signal or the like, for example, to transmit the identifier.

Communication module 201, discussed above, may also initiate contact with a client device, for example. In an exemplary embodiment of the invention, if an identifier has been generated, communication module 201 may initiate contact with a client device by automatically placing a call to the client device, for example. In such an embodiment, communication module 201 may include, for example, an automatic dialer 207 to dial the phone number of the client device. In another embodiment of the invention, communication module 201 may include functionality to enable communication module 201 to communicate using Voice Over Internet Protocol (VoIP), for example. In such an embodiment, the communication module 201 may initiate contact with a client device by using an Internet connection, for example.

Online data provider 200 may also include a verification module 206 to verify the listing information. In an exemplary embodiment of the invention, verification module may compare the identifier generated and transmitted to the client device with an input received from the client device. In such an embodiment, if the identifier generated and transmitted to the client device and an input received from the client device match, verification module 206 may, for example, produce a signal to indicate that the listing information has been verified. Verification module 206 may then store the listing information in a storage 208 of the online data provider.

In an exemplary embodiment of the invention, the comparison module 204 and the verification module 206 may be combined to form one comparison/verification module (not shown). In such an embodiment, the combined comparison/verification module may receive inputted information from one or more sources, compare the information, and determine whether a match exists.

Illustrative Verification Process

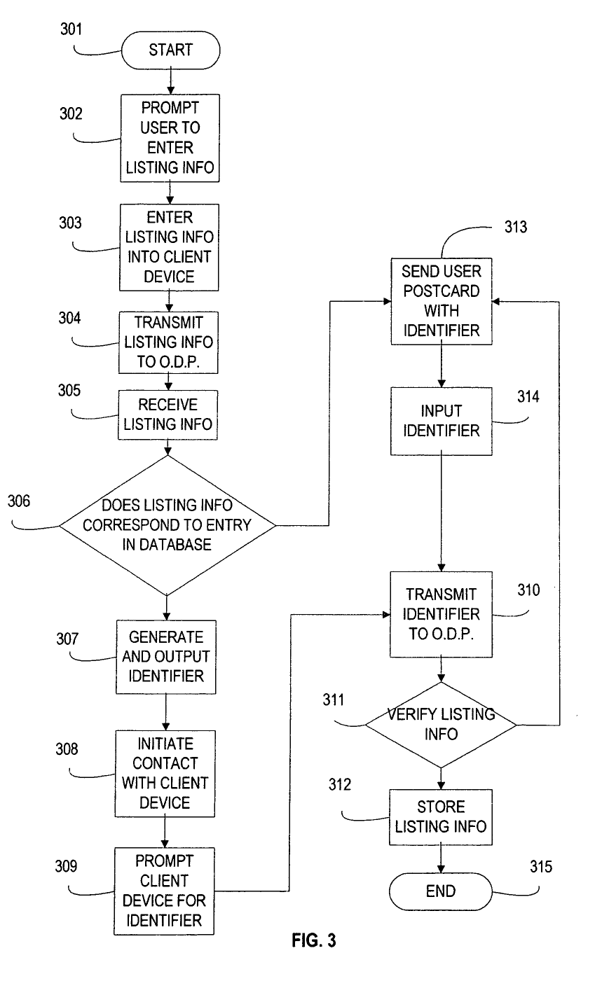

FIG. 3 illustrates a flow chart 300 showing an exemplary method for online data verification according to an embodiment of the invention. Flow chart 300 may begin at block 301. In block 302, a user associated with an entity may be prompted to enter listing information into a client device. To prompt the user associated with the client device, an online data provider may transmit via a network, for example, a Web page including data fields to receive data.

In block 303, the user associated with the entity may enter the listing information into the client device. In an exemplary embodiment of the invention, the user may, for example, type or speak the listing information into the client device using a keyboard/keypad or microphone, as described above. For example, a business enterprise may provide ABC Records, Inc., 123 Maple Street, Anytown, Anystate, 55555, (703) 555-5555 and may indicate that it accepts MASTERCARD and VISA as payment methods and is open M-S from 10-10 and on Sunday from 10-7.

In block 304, the listing information may be transmitted to the online data provider via a network, for example.

In block 305, the listing information may be received by the online data provider for verification.

In block 306, the online data provider may determine whether the listing information corresponds to an entry in a database, such as, for example, a 411 database as described above. In an exemplary embodiment of the invention, to determine whether the listing information corresponds to an entry in a database, the online data provider may determine whether the database contains an entry corresponding to the entity. For example, the telephone listing for ABC Records, Inc. may be searched in a business telephone listing 411 directory database to which the online data provider is operatively connected and has a pre-arranged relationship to be able to access through a network connection. If the database contains an entry corresponding to the entity, the online data provider may determine whether a match exists between a field of the entry and the listing information.

In block 307, an identifier may be generated and output to the client device. In an exemplary embodiment of the invention, the identifier may be an identifier such as, e.g., a randomly generated number or alphanumeric string of characters such as 5431. To output the identifier to the client device, the online data provider may, for example, transmit the identifier to be displayed on a monitor of the client device via a Web page, for example. A user may then record the identifier for later use. In another exemplary embodiment of the invention, the identifier may be transmitted to the client device as an audio file to be played on the client device using an audio file player, for example.

In block 308, contact with the client device may be initiated. As described above, the client device may be a phone or any like device capable of receiving a phone call. To initiate contact with the client device, in an exemplary embodiment of the invention, the online data provider may transmit the phone number included in the listing information, for example, to an automatic dialer. The automatic dialer may then attempt to initiate contact with by placing a phone call to the client device, for example. In the example given, ABC Records' telephone number of (703) 555-5555 may be dialed.

Once contact is initiated, a user associated with the client device may be prompted to provide the identifier in block 309. To provide the identifier, the user may type or speak the identifier into a phone, for example. In an exemplary embodiment where the user types the into the phone, the user may use a keypad on the phone, for example, to type in the identifier. In the specific example, if the user inputs 5431, that information is received for further processing. In an exemplary embodiment of the invention where the user speaks the listing information into the phone, the user may speak into a microphone of the phone, for example, and voice data may be transmitted to the online data provider where it is converted into data.

The identifier may then be transmitted to the online data provider in block 310.

In block 311, the online data provider may verify the listing information using the identifier transmitted to the client device and the identifier received from the client device. In an exemplary embodiment of the invention, the online data provider may use a comparison algorithm to determine whether the identifier transmitted to the client device and the identifier received from the client device are the same. In the specific example, because the PIN of 5431 matched the PIN of 5431 provided online to the listing requesting entity, verification has been made that the person requesting the listing had access to the telephone number stored in the 411 database of business listings, at least at the time of the listing request. This tends to further verify the validity of the business listing information.

In block 312, the listing information may be stored in an online index. In an exemplary embodiment of the invention, the online index may be accessible by users of, e.g., the world wide web, who desire to search for and obtain the listing information using, for example, a search engine.

In block 313, if for example, the online data provider that the listing information does not correspond to an entry in a database (block 306) or the online data provider cannot verify the listing information (block 311), the user associated with the client device may be sent via mail, for example, a postcard or the like that includes an identifier.

In block 314, the user that receives the postcard or the like may input the identifier. In an exemplary embodiment of the invention, in block 314, the user associated with the entity may follow instruction that are on the postcard or the like, for example, to log on to the online data provider's web site, for example, and enter the identifier. In such an embodiment, the user may, for example, type or speak the identifier into the client device or some other like device, using a keyboard/keypad or microphone, as described above. This identifier may then be transmitted to the online data provider as described above (block 310) and the listing information may be verified and listed (blocks 311-312).

Flow chart 300 may end at block 315.

Illustrative Interfaces

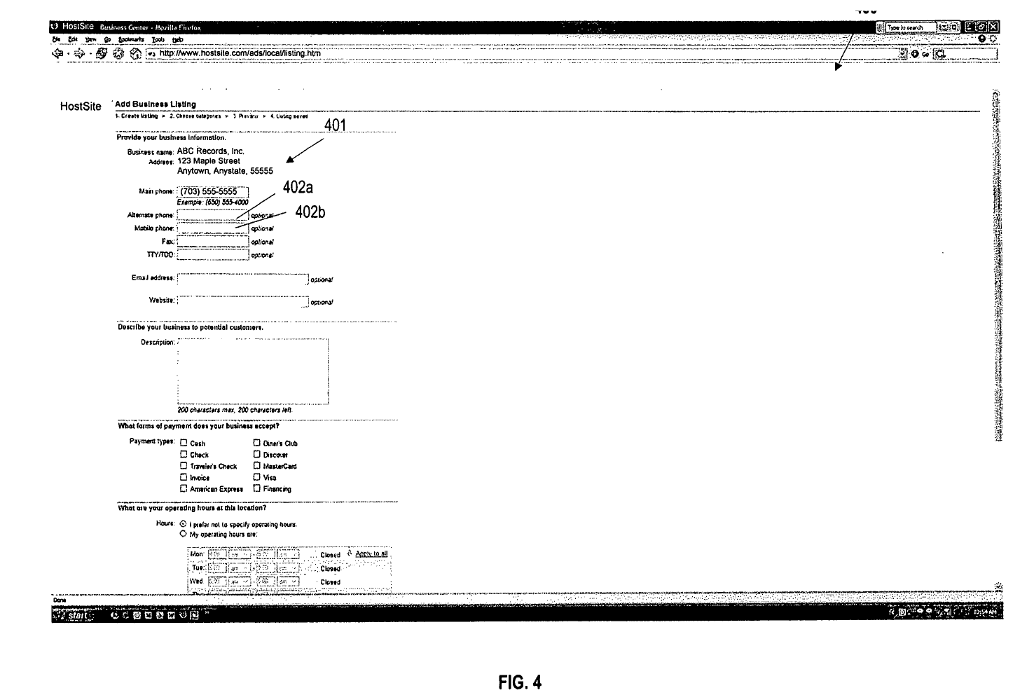

FIG. 4 illustrates an exemplary interface 400 according to an embodiment of the invention. In an exemplary embodiment of the invention, interface 400 may enable a user, for example, to create or modify a business listing. Interface 400 may include, for example, listing information 401 and data fields such as, e.g., data fields 402a-b that may enable a user to enter and/or modify listing information.

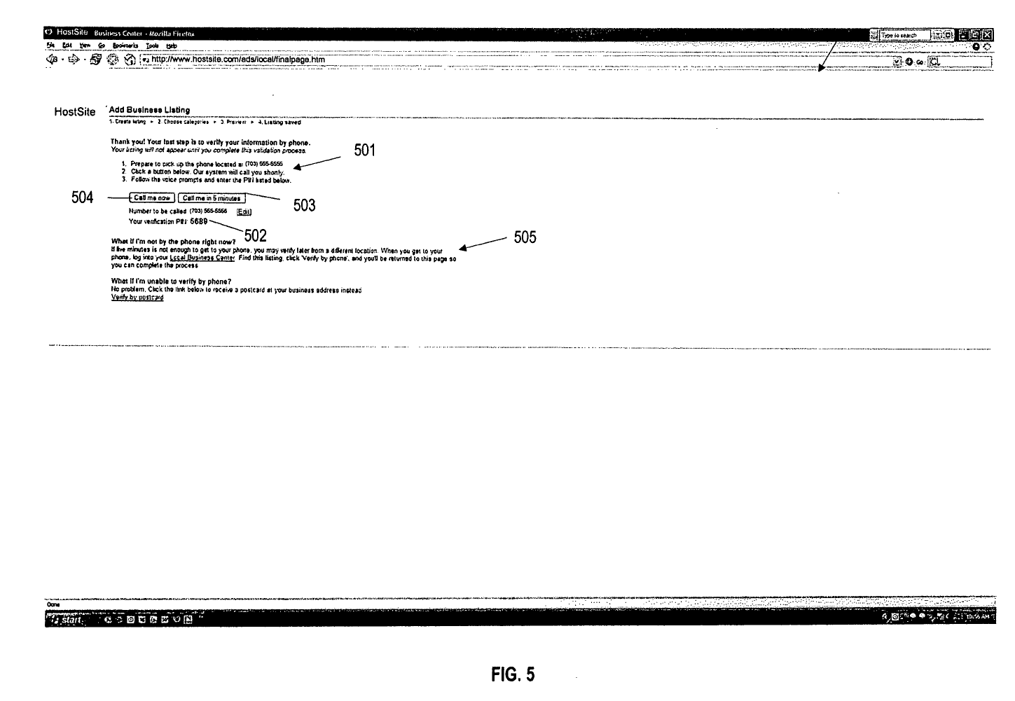

FIG. 5 illustrates an exemplary interface 500 according to an embodiment of the invention. In an exemplary embodiment of the invention, interface 500 may provide a user with an identifier that may be used during the listing information verification process. Interface 500 may include, for example, instructions 501 that may instruct the user on how to begin the verification process, an identifier 502, buttons 503, 504 that may enable the user to tell an online data provider when to initiate contact with the user, and troubleshooting messages 505.

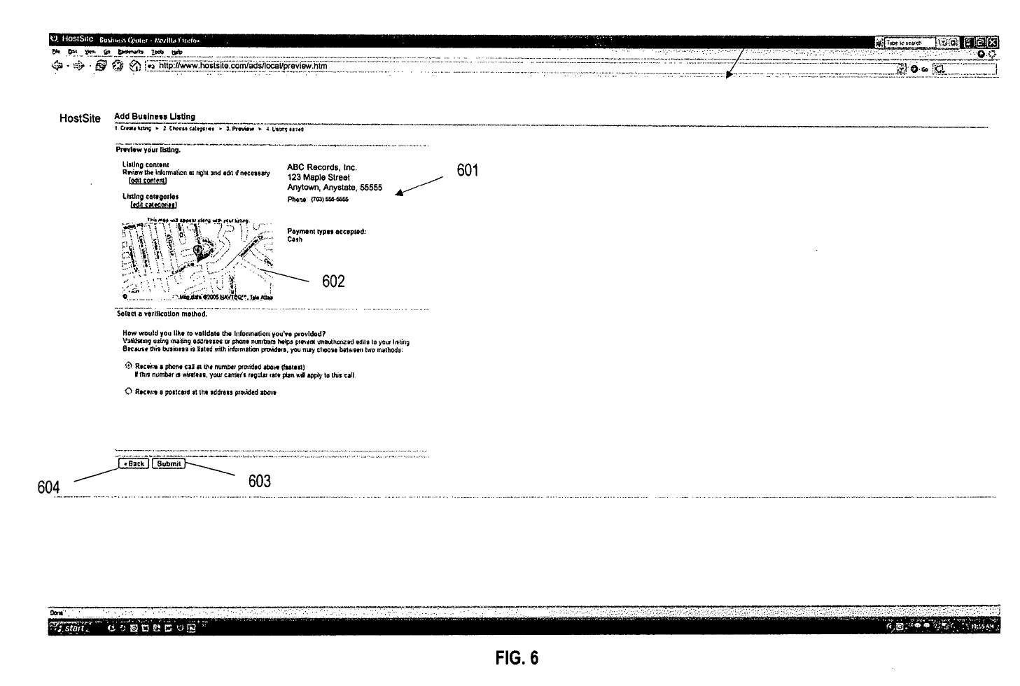

FIG. 6 illustrates an exemplary interface 600 according to an embodiment of the invention. In an exemplary embodiment of the invention, interface 600 may enable a user to preview the listing information. Interface 600 may include, for example, listing information 601 and a map 602. If a user is satisfied with the listing information, the user may then click a button 603 to submit the listing information for verification, for example. If the user is not satisfied with the listing information, or wishes to make any changes to the listing information, the user may click a button 604 to revise the listing information, for example.

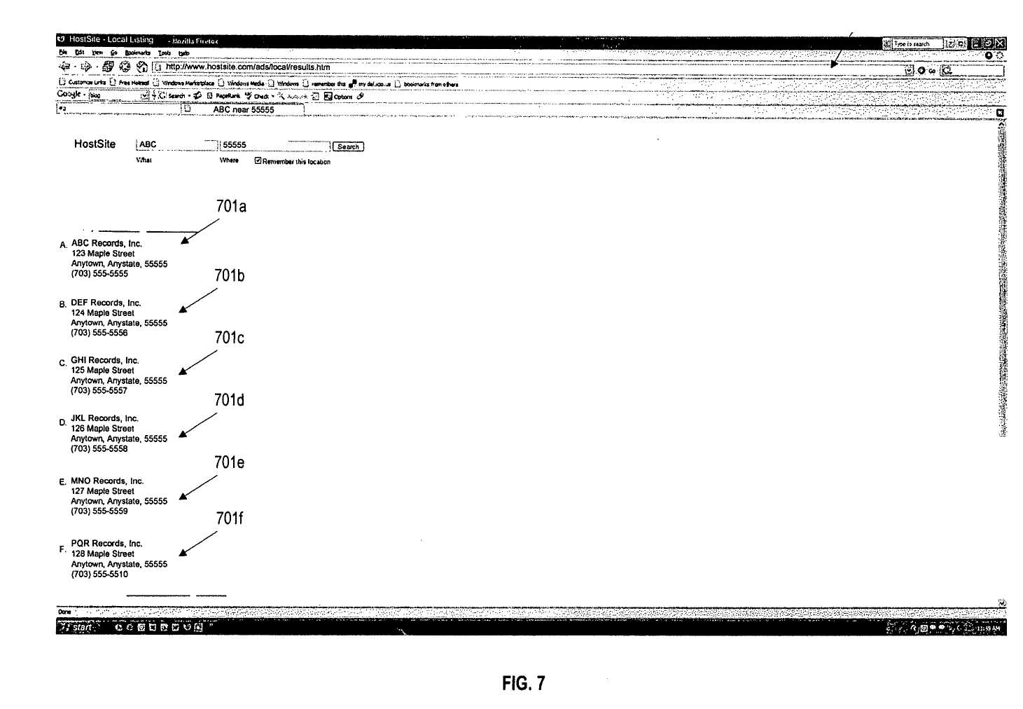

FIG. 7 illustrates an exemplary interface 700 according to an embodiment of the invention. In an exemplary embodiment of the invention, listing 700 may display listings 701a-f to a user. In such an embodiment, listings 701a-f may be stored in an online and/or web-based index or the like.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A method, comprising:
receiving listing information associated with an entity;
determining whether the listing information corresponds to an entry in a database;
generating an identifier based on whether the listing information corresponds to an entry in a database;
outputting the identifier to a user associated with the entity;
initiating contact with the user using the listing information;
receiving input from the user; and
verifying the listing information using the input and the identifier.

2. The method according to claim 1, further comprising:
storing the listing information in an online index.

3. The method according to claim 1, further comprising:
providing the user with an interface to enter listing information.

4. The method according to claim 1, wherein outputting the identifier to the user comprises transmitting the identifier to a client computer and displaying the identifier to the user.

5. The method according to claim 1, wherein initiating contact with the user comprises automatically placing a phone call to a phone number associated with the listing information.

6. The method according to claim 1, wherein receiving input from the user comprises one of receiving input from a keypad of a phone or receiving voice data via a phone.

7. The method according to claim 1, wherein determining whether the listing information corresponds to an entry in a database comprises:
determining whether a database contains an entry corresponding to the entity; and
determining whether a match exists between a field of the entry and the listing information, based on whether the database contains an entry corresponding to the entity.

8. The method according to claim 1, further comprising:
sending the user a postcard based on whether the listing information corresponds to an entry in the database.

9. A system, comprising:
a listing input module to receive listing information associated with an entity;
a comparison module operatively connected to the listing input module to receive the listing information and determine whether the listing information corresponds to previously stored information;
an identifier module that generates an identifier based on whether the listing information corresponds to previously stored information and output the identifier;
a communication module to initiate contact with a device associated with the entity based on the contents of the listing information and receive input from the device; and
a verification module to verify the listing information using the input and the identifier.

10. The system according to claim 9, wherein the communication module initiates contact with the client device by automatically placing a phone call.

11. The system according to claim 9, wherein input from the client device includes one of voice data or input from a keypad of a phone.

12. The system according to claim 9, wherein, to determine whether the listing information corresponds to previously stored information, the comparison module determines whether a database contains an entry corresponding to the entity and whether a match exists between a field of the entry and the listing information, based on whether the database contains an entry corresponding to the entity.

13. The system according to claim 9, wherein, to output the identifier to the client device, the online data provider transmits the identifier to the client device and the client device displays the identifier.

14. A system, comprising:
a client device to provide listing information associated with an entity;
a database including a plurality of entries; and
an online data provider to receive the listing information, determine whether the listing information corresponds to one of the plurality of entries, generate an identifier, output the identifier to the client device, initiate contact with the client device, receive input from the client device, and verify the listing information using the identifier and the received input.

15. The system according to claim 14, wherein the online data provider initiates contact with the client device by automatically placing a call to the client device.

16. The system according to claim 14, wherein input includes one of voice data or input from a keypad of a phone.

17. The system according to claim 14, wherein the online database stores the verified listing information in an online index.

18. A system, comprising:
a listing input module to receive listing information associated with a commercial entity, wherein the listing information includes at least one of a name, an address, a phone number, a website, an email address, or business operation information associated with the commercial entity;
a comparison module operatively connected to the listing input module to receive the listing information and determine whether the listing information corresponds to previously stored information, wherein to determine whether the listing information corresponds to previously stored information, the comparison module determines whether a database contains an entry corresponding to the commercial entity and whether a match exists between a field of the entry and the listing information, based on whether the database contains an entry corresponding to the commercial entity;
an identifier module that generates an identifier based on whether the listing information corresponds to previously stored information and displays the identifier on a monitor associated with the entity;
a communication module to initiate contact with a device associated with the entity based on the contents of the listing information and receive input from the client device, wherein to initiate contact with the device, the communication module places a call to the device and wherein a user associated with the device types in the input on a keypad of the device; and
a verification module to verify the listing information by determining whether the input from the client device matches the identifier.

19. A method for verifying an online commercial listing, comprising:
receiving listing information associated with a commercial entity;
determining whether a database contains an entry corresponding to the commercial entity;
determining whether a match exists between a field of the entry and the listing information, based on whether the database contains an entry corresponding to the entity;
generating an identifier based on whether the listing information corresponds to an entry in a database;
displaying the identifier on a monitor associated with the commercial entity;
initiating contact with the user by placing a phone call to a user associated with the commercial entity using a phone number included in the listing information;
receiving input from the user; and
verifying the listing information determining whether the input matches the identifier.
